(19) United States
(12) Patent Application Publication
(10) Pub. No.: US 2016/0099092 A1
(43) Pub. Date: Apr. 7, 2016

(54) COAXIAL CABLE

(71) Applicant: Hitachi Metals, Ltd., Tokyo (JP)

(72) Inventors: Detian HUANG, Hitachi (JP); Takanobu WATANABE, Hitachi (JP); Kimika KUDO, Kitaibaraki (JP)

(73) Assignee: Hitachi Metals, Ltd., Tokyo (JP)

(21) Appl. No.: 14/859,434

(22) Filed: Sep. 21, 2015

(30) Foreign Application Priority Data
Oct. 7, 2014 (JP) 2014-206381

(51) Int. Cl. H01B 11/18

(52) U.S. Cl. CPC H01B 11/1808

(57) ABSTRACT

A coaxial cable includes an inner conductor, an insulation around the inner conductor, an outer conductor around the insulation, and a metal foil tape around the outer conductor. The metal foil tape includes a metal foil and a conductive adhesive layer formed on a side of the metal foil and is lap-wound around the outer conductor such that the conductive adhesive layer is in contact with the outer conductor.

The present application is based on Japanese patent application No.2014-206381 filed on Oct. 7, 2014, the entire contents of which are incorporated herein by reference.

### BACKGROUND OF THE INVENTION

1. Field of the Invention

The invention relates to a coaxial cable suitably used as a wireless LAN antenna for sending and receiving high-frequency signals with a frequency of not more than 6 GHz.

2. Description of the Related Art

With the remarkable spread of broadband, wireless LANs are rapidly becoming popular and wireless LAN antennas for sending and receiving high-frequency signals with a frequency of not more than 6 GHz are now mounted, of course, on smartphones and tablet computers, etc., and even on televisions and air conditioners etc. A coaxial cable composing a wireless LAN antenna is provided with an inner conductor, an insulation formed around the inner conductor, an outer conductor formed around the insulation and a jacket around the outer conductor. As shown in FIG. 2, when wiring a coaxial cable 200, an outer conductor 201 needs to be grounded at a predetermined longitudinal position of the cable to take anti-noise measures. Thus, after exposing the outer conductor 201 by removing a part of a jacket 202 at the predetermined position, a metal clamp 203 is attached to the outer conductor 201 and is also electrically connected to a ground wiring 204 of a circuit board (see e.g. JP-A-2013-093137).

### SUMMARY OF THE INVENTION

To remove the jacket 202 without damaging the outer conductor 201 at all is a very difficult and troublesome task even for skilled workers. Meanwhile, if a connector terminal 205 is attached to an end portion of the coaxial cable 200 before removing the jacket 202, the connector terminal 205 may be damaged when removing the jacket 202. Thus, the connector terminal 205 may be practically attached after removing the jacket 202. In this case, however, there is a possibility that the jacket 202 may move in attaching the connector terminal 205 and the exposed portion of the outer conductor 201 may be thus misaligned with the predetermined position, making it difficult to ground the outer conductor 201. This problem can be solved by providing no jacket around the outer conductor, i.e. by forming an unjacketed cable (or a cable with no jacket formed thereon). However, if no jacket is provided around the outer conductor, e.g., when bending the coaxial cable, the distance between the inner conductor and the outer conductor may vary so as to cause a variation in impedance.

It is an object of the invention to provide a coaxial cable that can prevent a variation in impedance even if it is provided with no jacket.

(1) According to one embodiment of the invention, a coaxial cable comprises:
an inner conductor;
an insulation around the inner conductor;
an outer conductor around the insulation; and
a metal foil tape around the outer conductor,
wherein the metal foil tape comprises a metal foil and a conductive adhesive layer formed on a side of the metal foil and is lap-wound around the outer conductor such that the conductive adhesive layer is in contact with the outer conductor.

In the above embodiment (1) of the invention, the following modifications and changes can be made.
(i) The metal foil tape comprises an aluminum foil or a tin-plated copper foil.
(ii) The conductive adhesive layer comprises a hot-melt conductive adhesive.
(iii) The metal foil tape is electrically connected to the outer conductor via the conductive adhesive layer throughout an entirety of the coaxial cable.

### EFFECTS OF THE INVENTION

According to one embodiment of the invention, a coaxial cable can be provided that can prevent a variation in impedance even if it is provided with no jacket.

### BRIEF DESCRIPTION OF THE DRAWINGS

Next, the present invention will be explained in more detail in conjunction with appended drawings, wherein:

FIG. 1 is a cross sectional view showing a coaxial cable of the present invention; and

FIG. 2 is an illustration diagram showing the terminal process of the coaxial cable in the prior art.

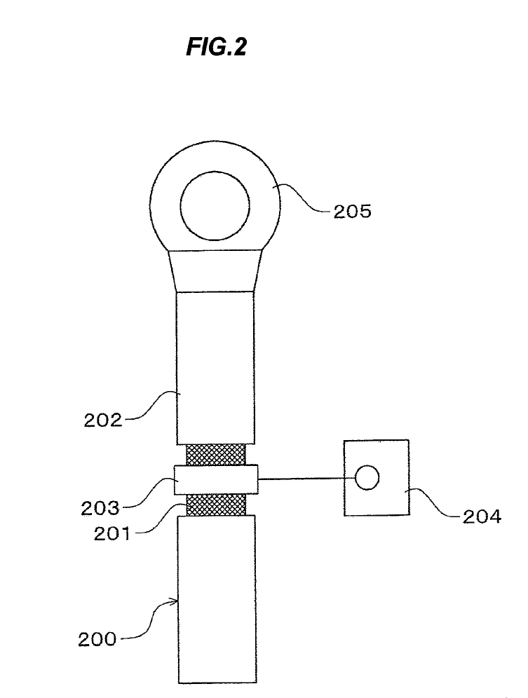

### DETAILED DESCRIPTION OF THE PREFERRED EMBODIMENTS

A preferred embodiment of the invention will be described below in conjunction with the appended drawings.

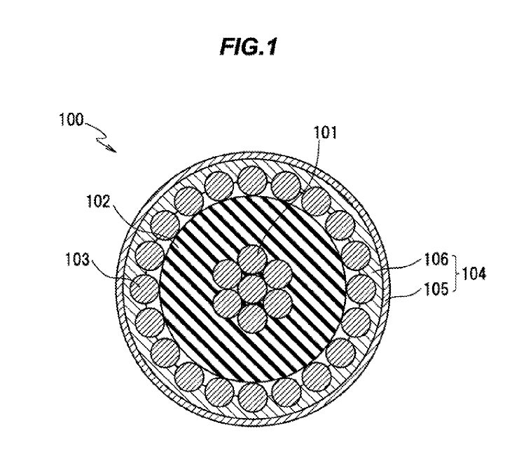

As shown in FIG. 1, a coaxial cable 100 in the preferred embodiment of the invention is provided with an inner conductor 101, an insulation 102 provided around the inner conductor 101, an outer conductor 103 provided around the insulation 102, and a metal foil tape with conductive adhesive layer 104 wound around the outer conductor 103.

The inner conductor 101 is formed of a solid wire or a twisted wire which is formed of a highly conductive metal such as copper with a tin-plated surface. The insulation 102 is formed of a resin with high insulation properties such as fluorine resin. The outer conductor 103 is formed of plural strands each formed of a highly conductive metal such as copper with a tin-plated surface.

The outer conductor 103 may be either a wrapped outer conductor formed by spirally winding plural strands around the insulation 102, or a braided outer conductor formed by braiding plural strands in a mesh around the insulation 102.

The metal foil tape with conductive adhesive layer 104 has a metal foil 105 and a conductive adhesive layer 106 applied to one side of the metal foil 105, and is lap-wound (i.e., forming a lap winding) around the outer conductor 103 such that the conductive adhesive layer 106 is in contact with the outer conductor 103.

The metal foil 105 is preferably constructed from an aluminum foil or a tin-plated copper foil. Accordingly, an oxide film on the surface of the metal foil 105 prevents progress of corrosion inside the metal foil 105 even if human sebum (skin oil) is attached to the surface of the metal foil 105 during handling of the coaxial cable 100 or the coaxial cable 100 is exposed to a high-temperature and high-humidity environment, and it is therefore possible to maintain anti-noise properties of the coaxial cable 100 for a long period of time. Particularly when the tin-plated copper foil is used as the metal foil 105, improvement in solder wettability by the tin plating is expected.

The conductive adhesive layer 106 is preferably formed of a hot-melt conductive adhesive. Thus, the conductive adhesive layer 106 can be applied to every corner of the outer conductor 103 by heating the coaxial cable 100 after winding the metal foil tape with conductive adhesive layer 104 and the outer conductor 103 thus can be firmly fixed, resulting that variation in impedance caused by unbraiding or looseness of strands constituting the outer conductor 103 can be suppressed.

As described above, in the coaxial cable 100 in the preferred embodiment of the invention, since the metal foil tape with conductive adhesive layer 104 has a function as a jacket, a distance between the inner conductor 101 and the outer conductor 103 is less likely to vary even when, e.g., bending the coaxial cable 100 and it is thereby possible to suppress variation in impedance and to constantly maintain good anti-noise properties. In addition, since the outer conductor 103 and the metal foil 105 are electrically connected to each other via the conductive adhesive layer 106 throughout the entire length of the cable, it is possible to easily electrically connect the outer conductor 103 to a ground wiring of a circuit board at any position of the coaxial cable 100. Furthermore, since the cable is unjacketed, damage on the outer conductor 103 due to jacket removal never occurs.

As described above, the invention provides a coaxial cable that can prevent a variation in impedance even with no jacket formed the outer conductor.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A coaxial cable, comprising:
an inner conductor;
an insulation around the inner conductor;
an outer conductor around the insulation; and
a metal foil tape around the outer conductor,
wherein the metal foil tape comprises a metal foil and a conductive adhesive layer formed on a side of the metal foil and is lap-wound around the outer conductor such that the conductive adhesive layer is in contact with the outer conductor.

2. The coaxial cable according to claim 1, wherein the metal foil tape comprises an aluminum foil or a tin-plated copper foil.

3. The coaxial cable according to claim 1, wherein the conductive adhesive layer comprises a hot-melt conductive adhesive.

4. The coaxial cable according to claim 1, wherein the metal foil tape is electrically connected to the outer conductor via the conductive adhesive layer throughout an entirety of the coaxial cable.
